(19) United States
(12) Patent Application Publication
(10) Pub. No.: US 2004/0110564 A1
(43) Pub. Date: Jun. 10, 2004

(54) Telecommunication system, particularly for transferring software programs, adapted method and slide-in cassette

(76) Inventors: Thomas Kern, Munchen (DE); Martin Kranz, Munchen (DE)

Correspondence Address: Rocco S Barrese, Dilworth & Barrese, 333 Earle Ovington Boulevard, Uniondale, NY, 11553, US

(21) Appl. No.: 10/250,356

(22) PCT Filed: Nov. 22, 2001
(86) PCT No.: PCT/EP01/13607

(30) Foreign Application Priority Data
Dec. 28, 2000 (DE) 10065471.1

(51) Int. Cl. A63F 13/00

(52) U.S. Cl. 463/42

(57) ABSTRACT

The invention relates to a telecommunication system, a method for operating said telecommunication system and a slide-in cassette which provides the user with improved operating convenience when selecting data from software programs. According to the invention, the telecommunication system comprises a switching unit for providing a software program, at least one mobile radio station associated with the switching unit and a user support configured specially for the software program.

The present invention relates to a telecommunications system and a method suitable for operating the telecommunications system, as well as a plug-in unit provided for this purpose.

Until now, typical telecommunications systems operated using mobile radio stations, in the form of mobile telephones, for example, software programs being used via the mobile radio stations using typical WAP technology. In this case, the mobile radio unit only uses one display setting, so that no further animations are possible, which does not address an increasing need of the user for variety. The software program as such is not loaded onto the mobile radio station.

Furthermore, preparing mobile radio stations, mobile telephones, for example, in such a way that, for example, a certain change of the animation is possible in existing software, which is supplied with the mobile radio set, by downloading files and/or data formats specially designed for this purpose, is known. Game software of this type present on the mobile radio stations is known by the name “embedded games”. Systems are also commercially available in which multiple user consoles may be connected using radio technology, in order to thus provide a multiplayer system. In this case, the respective mobile telephones provided with the game software communicate, however, merely a special data format is transmitted in this case, as in all the other known cases, not a complete software program.

The system described above has the disadvantage that, for example, the mobile telephone and/or the mobile radio station, which is normally equipped for telephony, is not equipped with the operating elements for the respective software program. In addition, the typical systems each require a mobile radio station and/or a mobile telephone, which must be continuously activated, and therefore is not available for another use during the usage of the software program. In addition, the typical systems are not able to provide a suitable platform and/or a suitable display. Furthermore, the mobile telephones equipped for speech transmission only have restricted technology, i.e., there is no possibility for expansion to further applications, for example, operating games and/or special software programs. All in all, the user friendliness therefore leaves much to be desired. If, in addition, a special WAP browser is used for operating the special software program, as is provided in typical systems, a radio link, for example from the mobile radio station to the switching unit, must exist continuously during the operation of the special software program, so that the respective user remains unreachable.

In contrast, known user consoles exist which use a special plug-in unit, on which a software program is stored. If the user now has the desire to retrieve different software programs, the producer of the user console offers the ability to activate the desired software program by replacing the plug-in unit. In this way, the producer of the user console also has the possibility in the future of offering further developments and/or other software programs to the user merely by providing the plug-in unit. However, the system has the disadvantage that the user must have multiple plug-in units continuously accessible in order to retrieve the software programs as desired. It is also typical in the course of current further developments that the interest of the user in older software programs falls rather rapidly, so that the number of plug-in units increases to an enormous scale very rapidly.

In contrast, it is the object of the present invention to avoid the disadvantages of the related art described above. Furthermore, it is the object of the present invention to provide a telecommunications system, a method for operating the telecommunications system, and a plug-in unit suitable for this purpose, with which increased user friendliness is provided, to design special software programs which are playable via mobile radio stations, and to reduce the data transfer to a minimum.

According to the present application, these objects are achieved for the devices with the features of claim 1 and/or claim 21 and for the method with the features of claim 12.

According to the present application, a telecommunications system and/or method for operating the telecommunications system is therefore provided, the telecommunications system comprising a switching unit for providing a software program, at least one mobile radio station assigned to the switching unit, and a user console configured especially for the software program. Using these components, the mobile radio stations are only stressed and/or not reachable for the time which is necessary for transmitting the software program from the switching unit to the user console. After the transmission, the desired software program is available to the user and the user himself is simultaneously also reachable via the mobile radio station again. Using this system, it is therefore possible to intentionally only retrieve the software programs which the user wishes to use via his user console.

This avoids multiple plug-in units—as in the related art—continuously having to be kept ready. Furthermore, it may be ensured using the system according to the present application that the update of the software program may be made available to the users without problems, so that the entire system may also be seen as environmentally friendly. In addition, backward compatibility in regard to the software programs may be provided according to the present application. It is to be noted that a radio connection between the user console and the switching unit must only be made available for the period of time which is necessary for the data transmission of the software program. Using the telecommunications system and/or using the method for operating the telecommunications system according to the present application, the possibility of improved charging of fees for the use of special software programs is therefore also provided. On the basis of each connection established, the switching unit may thus charge a fee in a targeted way, which in turn is only charged to the users account for using the download of the software program, without the user having to pay the entire price for the software program, which is made available in a typical ways, in the plug-in unit or via known data carriers.

Further advantageous embodiments of the present invention are the object of the subclaims.

If the user console is provided with a first memory element, preferably a RAM module, in which the software program is temporarily storable, then targeted charging of fees may be carried out. In addition, product pirating, which is always spreading, is counteracted, since a normal user is largely excluded from being able to copy the software program due to the temporary storage of the software program.

If the user console and the mobile radio station have interfaces which are tailored to one another, which may preferably be a serial interface or an infrared interface, the possibility of transmitting the software programs via the mobile radio stations in a typical way is provided, without a hardware-specific alteration having to be performed in this case.

If the user console has a second memory element having the operating software program, the presence of the operating software ensures that the transmitted software is tailored to the user console in a targeted way. It has been shown to be advantageous if the user console has a removable device which contains the first memory element, the second memory element, and the interface, in order to thus be exchanged between different user consoles, which are specially constructed for the removable device.

If, in addition, the removable device of the user console is constructed with the same shape as a plug-in unit, typically provided for exchange, having software programs of the user console, the possibility arises of also using commercially available user consoles, which use specially provided plug-in units, in the telecommunications system according to the present application. In other words, if a user already has a user console with plug-in units, the plug-in unit according to the present application must only be used in order to also be able to profit from the continuous, sometimes necessary updates. This is done in such a way that in the future no further plug-in units have to be purchased, but rather a link to the switching unit merely has to be established via the mobile radio station, in order to transmit the updated software programs to the user console.

If the user console or the removable device additionally has an management element, which is connected to a third memory element, preferably a RAM module, then the data necessary for the software program may be partially temporarily stored and possibly made available to the user console again depending on the software program used. In the case of game software as a software program, the management element having the memory element is suitable for the purpose of providing individual parameters such as scores and/or basic data, which must be made available for the software program at a later point in time.

For smooth and/or reliable operation using the telecommunications system according to the present invention, it has been shown to be an advantage if the operating software program is equipped at minimum with an operating component, a selection component, a connection component, an emulator component, and/or a program component. These components ensure that no further outlay for programs is necessary by the user in order to operate updated software programs in the user console.

In this case, it has been shown to be advantageous if the operating component manages the first memory element and/or the interface, the selection component represents the graphic interface to the user and generates virtual interfaces, the connection component allows access to a central server of the switching unit and coordinates the data transfer of the software program between the connection unit and the mobile radio station, the emulator component functions as an intermediary between the software program and the user console, and/or the program component manages the execution of the software program.

As already mentioned, the telecommunications system according to the present application and/or the method according to the present application has been shown to be particularly suitable for the users who frequently use a game program has a software program and use the user console in the form of a game console, since specially equipped and/or configured game consoles particularly meet the requirements of the user, i.e., there are special function elements, such as buttons and/or joysticks, which support the execution of game programs in the best possible way.

Since typically mobile telephones have been widely distributed in the meantime as mobile radio units, these mobile telephones are best suitable for use in the telecommunications system and/or in the method for operating the telecommunications system according to the present application.

It is also advantageous, due to the configuration of the telecommunications system, if the user console is equipped, through the possibility of loading software programs via a mobile radio station, for the purpose of causing the retrieval of the software programs present in the switching unit by the user console via the mobile radio station. In this regard, the possibility is also given to the user, through the user console known to him, of activating the user console using the interface merely by selecting a number via the mobile radio station, and activating the transmission of the software program via a special selection menu within the user console.

If the software program is erased from the first memory element when the user console is switched off, it is ensured that identical starting conditions exist when the user console is subsequently switched on, and the possibility is particularly provided of performing the exchange of the software programs in a controlled way.

Further advantageous embodiments of the present invention are the object of the remaining subclaims.

An exemplary embodiment of the system according to the present application and/or of the plug-in unit according to the present application is illustrated with reference to the attached drawing.

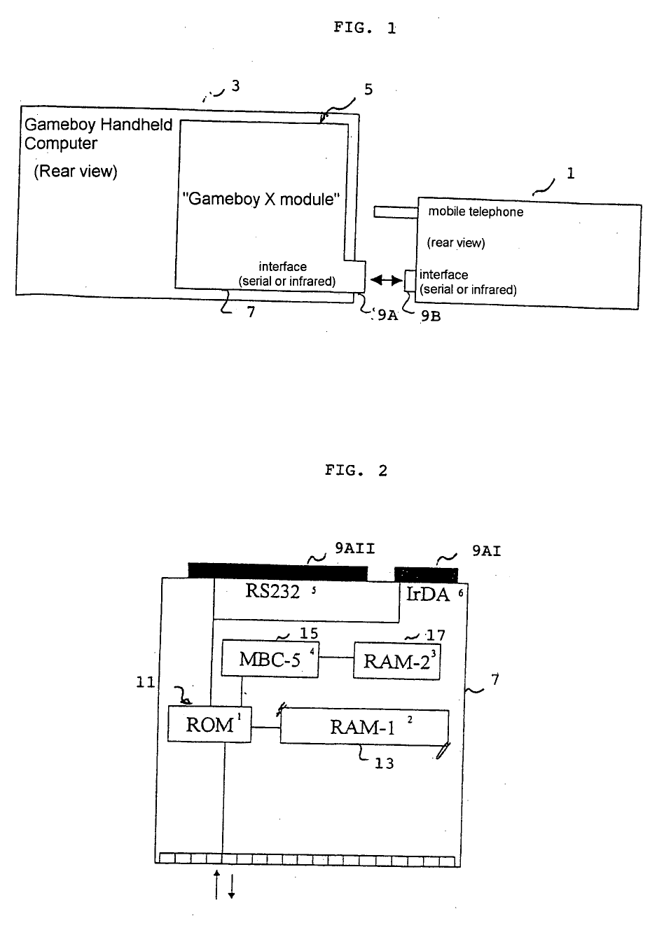

FIG. 1 shows the interaction between the mobile radio station and the user console according to one embodiment of the telecommunications system; and

FIG. 2 shows the construction of the plug-in unit according to the present application, which is used in the system shown in FIG. 1.

FIG. 1 shows a mobile radio station 1, which is illustrated in this embodiment as a mobile telephone. In addition, a user console 3 is illustrated, which has a removable device 5, which in this form is illustrated as a plug-in unit 7. It may also be clearly seen that plug-in unit 7 communicates with mobile radio unit 1 via the interface (see right-left arrow). Optionally, the interface may be equipped as either a serial interface or as an infrared interface. Mobile radio station 1 communicates with a switching unit (not shown), which contains the software program to be transmitted.

In FIG. 2, the respective components of plug-in unit 7 are illustrated, which in this embodiment has both the serial (9A II) and the infrared (9A I) interfaces. The respective interfaces are connected to second memory element 11, which is equipped in this embodiment as a ROM module. The operating system software, which contains the respective components, is integrated into the second memory element. The second memory element is connected to first memory element 13, in which, according to the present application, the software program may be temporarily stored. For this purpose, the first memory element is illustrated as a RAM module. Depending on the conditions, a management element 15 is also provided, which is connected to a third memory element 17, which is also preferably implemented as a RAM module. The management element having the third memory element is, however, only optionally necessary. Second memory element 11 is also connected to the output, which is implemented in a standard way between the removable device and/or plug-in unit and the user console, in order to a establish a contact to the user console in a typical way.

In the following, the mode of operation of the telecommunications system according to the present application and the special components, as well as the method of operating the telecommunications system, are described in more detail.

The second memory element contains a specially made operating software program, tailored to the user console, which is started when the user console is put into operation as a first element and which drives the internal hardware components and/or elements of the module. This special operating software program is also responsible for the smooth execution of each transmitted software program, for example, game program. The respective software program, which is downloaded from the Internet and/or transmitted, is temporarily stored on first memory element 13 and remains available to the user until deactivation of the user console. In order that the user may play the stored software program and/or game program, it is executed by the CPU of the user console. The memory capacity of the first memory element is laid out in such a way that every available software program and/or game program intended for the user console may be accommodated. The third memory element, whose memory capacity is smaller than that of the first memory element, is a module component, which makes it possible to secure certain parameters such as the score of a game software program, for example a game program, if an internal function of the software and the respective software program provide this. The third memory element is no longer supplied with power after being switched off, so that the parameters are also erased upon shutoff. Therefore, the resource is available, unoccupied, for a new software program and/or game every time it is switched on. Management element 15 is a standard component in regard to special software programs and/or game programs. Management element 15 is responsible for managing specific parameters, such as a specific oversize of characteristic data and memory space requirements and correctly filing them in the third memory element. This merely optional component may therefore, however, be an important component in regard to the universal compatibility of user consoles with existing software programs and/or game software programs. The RS232 interface is provided as a serial interface for the necessary data connection to the mobile radio station and/or mobile telephone. The data exchange is performed via cable in this case. Infrared interface 9A I is an alternative interface for the wireless data exchange of the mobile radio station and/or mobile telephone. It is noted here that in principle the user may control the specific transmission himself using the operating software program on the second memory element. The operating software program contained in the telecommunications system according to the present invention is more extensive than the operating software of a typical user console due to a necessary compatibility and/or universal compatibility.

While only the software program to be executed is stored on the normal user console, the operating software program according to the present application includes more specialized components. The operating component is used for the purpose of initializing other software modules, managing the first memory element, and/or activating the interfaces (serial and/or infrared). The selection component represents the graphic interface to the user. It allows the display of information, information about available software programs, and generates virtual buttons, for example, for confirming the transmission initialization. The connection component allows access to a central server of the switching unit, on which the software programs and possibly also files are stored, and coordinates the data transfer, i.e., initiation, execution, and checking of the software program data received, between the management unit and the mobile radio station. The emulator component functions as an intermediary between the software program and the user console, i.e., it functions as an intermediary between the software program stored on the first memory element and the executing component of the user console, i.e., CPU, RAM, etc. The program component manages the execution of the software component and, in the case of a game program, the program component manages the actual software program and/or game program which must be loaded onto the plug-in unit after the user console is switched on in order to be played.

The mode of operation of the telecommunications system according to the present invention is to be illustrated in more detail with the following process description.

In the first step, the user switches on the user console, in the preferred exemplary embodiment, the plug-in unit being plugged into the region of the user console already provided. The hardware of the user console accesses, in a standard way, the permanent memory, i.e., the second memory element of the plug-in unit, in which the operating software program is located, and executes this operating software program.

In the second step, a greeting dialogue and a selection menu are displayed. The operating component immediately initiates the selection component. A brief greeting appears on the display of the user unit and a virtual button is generated, which signals that now a connection must be established between the user console and the switching unit, the mobile radio station and/or the mobile telephone to be laid next to the user console for this purpose.

In the third step, the user initiates a connection to the switching unit and/or to the server of the switching unit. In the moment in which the user gives the command “connect to server”, the connection component is started, which, for example, activates the internal modem of the mobile telephone via the infrared interface. The internal modem in turn establishes a physical switched connection in the switching unit and/or to the server and/or Internet. When the physical connection exists, the connection component registers at the server and queries the content of the catalog and/or of the subcatalogs in which the software programs are stored and transmits this information to the selection component.

In the fourth step, the content of the software program catalog appears in list form on the display of the user console. The selection component represents the direct content of the software program catalog, which is accessible by the server and/or the switching unit, in list form. The user may now and start the download by pressing a button.

In the fifth step, the downloading and/or transmission of the software program and/or game program is performed.

If the user decides on a specific software program and/or game program from the list displayed via a button press, the connection component begins the transmission of the corresponding software program and/or the software program data. The connection component relays the arriving data packets into the first memory element of the telecommunications system. When all data packets have arrived, the connection component checks the completeness of the data packets and generates a program file, executable by the user unit, in the first memory element. Subsequently, the connection to the switching unit and/or to the server thereof is broken off. The corresponding command goes from the connection component to the modem in the mobile telephone and/or mobile radio station.

In the sixth step, the status signal and request to the user follows. The selection component informs the user whether the transmission procedure was successful or not. In the event of a transmission error, the user is offered the chance to perform the transmission again. In this case, step 5 is performed again. If the transmission was successful, the user is offered the chance to start the software program. Depending on the size of the software program, the mobile radio station and/or mobile telephone of the user is therefore only occupied for short time.

In the seventh step, the starting of the software program follows. If the user decides to start the software program and/or game program, the emulator component is initiated, which, upstream, in turn starts the actual program file, which is then executed by the user console. The user may now apply the software program. If the user wishes to load another software program, he must briefly turn his user console off. The method begins again at step 1 through switching on again.

However, it is also obvious that further embodiments of the telecommunications system according to the present application are possible, without having to leave the scope of protection.

Thus, for example, it is obvious that depending on the user contract between the user, to whom the mobile telephone belongs, and the switching unit, the software program may also be stored in the user console over a specific longer period of time and a specific number of start possibilities are made available to the user. It is clear from the description of the function above that now the possibilities of charging fees for various software programs may be performed in multiple ways. In particular, charging fees in accordance with the number of data packets transmitted is possible.

1. A telecommunications system, particularly for transmitting software programs, comprising
a) a switching unit for providing a software program,
b) at least one mobile radio station assigned to the switching unit and
c) a user console configured especially for the software program.

2. The telecommunications system according to claim 1, wherein the user console has a first memory element, preferably a RAM module, in which the software program may be temporarily stored.

3. The telecommunications system according to claim 1 or 2, wherein the user console and the mobile radio station have an interface tailored to one another, preferably a serial interface or an infrared interface.

4. The telecommunications system according to claim 3, wherein the user console has a second memory element, preferably a ROM module, having an operating software program.

5. The telecommunications system according to one of claims 1 to 4, wherein the user console has a removable device which has the first memory element, the second memory element, and the interface.

6. The telecommunications system according to claim 5, wherein the removable device of the user console has the same shape as a plug-in unit, having software programs of the user console, typically provided for exchange.

7. The telecommunications system according to one of claims 1 to 6, wherein the user console or the removable device has a management element, which is connected to a third memory element, preferably a RAM module.

8. The telecommunications system according to one of claims 4 to 7, wherein the operating software program contains an operating component, a selection component, a connection component, an emulator component, and/or a program component.

9. The telecommunications system according to claim 8, wherein the operating component manages the first memory element and/or the interface, the selection component represents the graphic interface to the user and generates virtual buttons, the connection component allows access to a central server of the switching unit and coordinates the data transfer of the software program between the switching unit and the mobile radio station, the emulator component functions as an intermediary between the software program and the user console, and/or the program component manages the execution of the software program.

10. The telecommunications system according to one of claims 1 to 9, wherein the software program is a game program and the user console is a game console.

11. The telecommunications system according to one of claims 1 to 10, wherein the mobile radio station is a mobile telephone having a suitable interface.

12. A method for operating a telecommunications system, particularly using the telecommunications system according to one of claims 1 to 11, which has the following steps:
a) providing a software program, preferably in a switching unit,
b) providing a mobile radio station assigned to the switching unit,
c) providing a user console configured especially for the software program; and
d) transmitting the software program to the user console.

13. The method according to claim 12, wherein the transmission of the software program is performed by establishing a connection between the switching unit and the radio station, and the radio station communicates with the user console via an interface, particularly a serial interface and/or an infrared interface.

14. The method according to one of claims 12 or 13, wherein the establishment of the connection between the user console and the switching unit is initiated from the user console via the mobile radio station.

15. The method according to one of claims 12 to 14, wherein the software program is loaded into a first memory element of the user console and temporarily stored.

16. The method according to one of claims 12 to 15, wherein the software program is started by an operating software program which exists in a second memory element.

17. The method according to one of claims 12 to 16, wherein the software program is erased from the first memory element when the user console is switched off.

18. The method according to one of claims 12 to 17, wherein the user console has a removable device, which has the first memory element, the second memory element, and the interface, and the removable device is designed as a plug-in unit, in order, for putting the system into operation, to be exchanged with an exchange module containing a permanently installed software program.

19. The method according to one of claims 12 to 18, wherein parameters of the software program are stored, preferably temporarily, in a third memory element via a management element, which is connected to the third memory element, preferably a RAM module.

20. The method according to one of claims 12 to 19, wherein the software program is a game program and a game console is used as the user console.

21. A plug-in unit, particularly for performing the method according to one of claims 12 to 20 and/or for the use of the telecommunications system according to one of claims 1 to 11, comprising a first memory element for storing a software program, a second memory element, an interface to a mobile radio station, and a connecting point for connection to a user console.

22. The plug-in unit according to claim 21, wherein the first memory element is a RAM module for storing a temporarily stored software program.

23. The plug-in unit according to one of claims 21 and 22, wherein the second memory element is a ROM module having an operating software program.

24. The plug-in unit according to one of claims 21 to 23, wherein the interface is a serial interface or an infrared interface.

25. The plug-in unit according to one of claims 21 to 24, wherein a management element having a third memory element, preferably a RAM module, for storing parameters of the software program is also provided.

26. The plug-in unit according to one of claims 21 to 25, wherein the software program is a game program.
